(19) United States
(12) Patent Application Publication
(10) Pub. No.: US 2019/0088943 A1
(43) Pub. Date: Mar. 21, 2019

(54) POSITIVE ELECTRODE PLATE FOR NONAQUEOUS ELECTROLYTE SECONDARY BATTERY, POSITIVE ACTIVE MATERIAL TO BE USED THEREFOR, AND SECONDARY BATTERY USING THE SAME

(71) Applicant: SUMITOMO METAL MINING CO., LTD., Tokyo (JP)

(72) Inventors: Mikako KATO, Niihama-shi (JP); Tetsutaro HAYASHI, Niihama-shi (JP); Koji KURIHARA, Niihama-shi (JP)

(73) Assignee: SUMITOMO METAL MINING CO., LTD., Tokyo (JP)

(21) Appl. No.: 16/083,130

(22) PCT Filed: Feb. 27, 2017
(86) PCT No.: PCT/JP2017/007377

§ 371 Date: Sep. 7, 2018

(30) Foreign Application Priority Data
Mar. 8, 2016 (JP) 2016-044033
Dec. 15, 2016 (JP) 2016-242991

(51) Int. Cl. H01M 4/485; H01M 10/0585

(52) U.S. Cl. CPC H01M 4/485; H01M 2004/028; H01M 10/0585

(57) ABSTRACT

A positive electrode plate for a nonaqueous electrolyte secondary battery, which enables an increased output of a battery and leads to decreased deterioration in battery performance when used as a positive electrode plate for the battery, is provided.

The positive electrode plate for a nonaqueous electrolyte secondary battery is provided, which has a positive electrode composed of a positive active material comprising a lithium metal composite oxide, and on the surface of the positive electrode, an amorphous coating layer formed of a compound containing niobium and lithium, wherein the compound is a lithium ion conductor. Accordingly, lithium ion conductivity in the electrode can be improved, and deterioration of the lithium ion conductivity and dielectricity in air can be suppressed. Moreover, with the use of the electrode plate, an increased output can be realized, and the positive electrode plate for a nonaqueous electrolyte secondary battery, the high output performance of which is not easily deteriorated when handled in air, can be provided.

### TECHNICAL FIELD

The present invention relates to a positive electrode plate for a nonaqueous electrolyte secondary battery, a positive active material to be used therefor, and a secondary battery using the same.

### BACKGROUND ART

In recent years, development of small and lightweight nonaqueous electrolyte secondary batteries having high energy density has been strongly desired as the spread of portable electronic equipment such as cellular phones and notebook personal computers. Moreover, development of high-output secondary batteries as batteries for electric cars including hybrid cars has been strongly desired. An example of a secondary battery that meets such a demand is a lithium ion secondary battery.

A lithium ion secondary battery is composed of a positive electrode containing a positive active material as a major component, a negative electrode containing a negative electrode active material as a major component, and a nonaqueous electrolytic solution, wherein materials for negative electrode active materials and materials for positive active materials used therein are capable of eliminating and inserting lithium.

Such lithium ion secondary batteries are currently under active research and development. A lithium ion secondary battery, in which layer-type lithium metal composite oxide is used as a positive electrode material, can produce high voltage as high as 4V, and thus is increasingly put into practical use as a battery having high energy density.

Examples of materials proposed to date include lithium-cobalt composite oxide (LiCoO₂) that can be relatively easily synthesized, and lithium-nickel composite oxide (LiNiO₂) in which nickel less expensive than cobalt is used, and lithium nickel cobalt manganese composite oxide (LiNi_{1/3}Co_{1/3}Mn_{1/3}O₂).

For development of the above lithium composite oxides for automobiles, it is important to improve them into materials for a positive electrode with which outputs higher than current outputs can be obtained, and specifically, to decrease the resistance of materials for a positive electrode.

Moreover, some of the above lithium composite oxides react with atmospheric moisture or carbon dioxide when handled in air, so as to form an inert layer, thereby inducing decreased capacity and increased resistance. Therefore, preventing deterioration of these positive active materials is important.

Patent Literature 1 proposes positive active material powder, comprising particles of a positive active material for a lithium ion secondary battery composed of a composite oxide containing Li and transition metal M as components, on which surface of the particles a lithium niobate coating layer is formed, wherein the carbon content is 0.025 mass % or less, and the average proportion of the total number of Nb atoms in the total number of Nb and M atoms distributed from the outermost surface of the coating layer to the etching depth of 1 nm is 70% or more, as determined by XPS depth profile analysis. However, an object thereof is to suppress an increase in the battery's internal resistance due to electrical resistance generated at the contact interface formed between solids, an active material and a solid electrolyte. The literature does not examine the improvement of the output characteristics of a nonaqueous electrolyte secondary battery in which a liquid nonaqueous electrolyte and an active material form an interface.

Patent Literature 2 proposes a positive active material, which is a lithium-nickel composite oxide comprising secondary particles composed of primary particles, in which the surface of the primary particles is partially coated with a lithium metal oxide layer, and the remaining surface area of the primary particles is coated with a cubic metal oxide layer, wherein the lithium metal oxide is at least one type selected from the group consisting of lithium metaborate, lithium niobate, lithium titanate, lithium tungstate, and lithium molybdate, the thickness of the lithium metal oxide layer is 0.5 nm or more and 5 nm or less, the cubic metal oxide is a nickel oxide, the thickness of the cubic metal oxide layer is 0.5 nm or more and 10 nm or less, the average coverage “x” of the lithium metal oxide layer is 0.85 or more and less than 0.95, and the coverage “y” of the metal oxide layer is 0.05 or more and less than 0.15 (x+y=1). The literature describes that in a lithium ion secondary battery charged with high voltage, a side reaction with a nonaqueous electrolytic solution can be suppressed upon charge and discharge, and battery capacity, cycle characteristics, and rate characteristics can be improved, however, the literature does not examine the improvement of output characteristics.

Non Patent Literature 1 reports that with the use of a pulsed laser deposition technique, a lithium metal oxide (Li₂WO₄) film having the properties of an ion conductor is formed on LiCoO₂, so as to: improve lithium diffusion at the interface of positive electrode/electrolytic solution; decrease the interface resistance; and create an amorphous state, thereby causing lithium diffusion paths to effectively function, accelerating an effect of reducing resistance, and thus improving output characteristics. However, the literature does not examine the effect of output characteristics in a case of coating with lithium niobate having the properties of an ion conductor as described in Non Patent Literature 2. Furthermore, the literature never mentions the effects on battery performance in a case of handling in air.

Non Patent Literature 3 reports that with the use of a sol-gel technique, output characteristics can be improved by coating LiCoO₂ with a metal oxide (BaTiO₃) having the properties of a dielectric. Moreover, Non Patent Literature 4 reports that lithium niobate exerts good dielectricity regardless of the crystal state. However, Non Patent Literature 3 never mentions the effect on battery performance in a case of using a dielectric other than BaTiO₃.

### CITATION LIST

### Patent Literature

[Patent Literature 1] Japanese Unexamined Patent Publication No. 2014-238957

[Patent Literature 2] Japanese Unexamined Patent Publication No. 2013-137947

### Non Patent Literature

[Non Patent Literature 1] J. Power Sources 305 (2016) 46.

[Non Patent Literature 2] J. Appl. Phys. 49 (1978) 4808.

[Non Patent Literature 3] APPLIED PHYSICS LETTERS 105 (2014) 143904.

[Non Patent Literature 4] APPLIED PHYSICS Vol. 54 (1985) 568.

### SUMMARY OF INVENTION

### Technical Problem

In view of the above problems, an object of the present invention is to provide: a positive electrode plate for a nonaqueous electrolyte secondary battery that makes it possible to increase the output of a battery when used as a positive electrode of the battery and leads to decreased deterioration of battery performance when the battery is handled in air; and a positive electrode material to be used for the electrode.

Another object of the present invention is to provide a nonaqueous electrolyte secondary battery capable of producing high output and exerting decreased deterioration of battery performance.

### Solution to Problem

The present inventor has intensively studied the various characteristics of a lithium metal composite oxide to be used as a positive active material for a nonaqueous electrolyte secondary battery in order to achieve the above objects. As a result, the present inventor has obtained: a finding such that the formation of an amorphous coating layer comprising a compound containing niobium and lithium on the surface of the lithium metal composite oxide improves lithium ion conductivity of the positive electrode plate and lithium insertion and de-insertion at the interface of the surface coating layer and the positive active material, and makes the lithium ion conductivity of the coating layer and the characteristics thereof as a dielectric difficult to be deteriorated in air; and a finding such that a significant decrease in electrolytic solution/positive electrode interface resistance of a secondary battery using the positive electrode plate can improve the output characteristics of the secondary battery, and suppress deterioration of battery performance when the secondary battery is handled in air, and thus has completed the present invention.

The positive electrode plate for a nonaqueous electrolyte secondary battery of a 1^{st} invention has a positive electrode composed of a positive active material comprising a lithium metal composite oxide, and on the surface of the positive electrode, an amorphous coating layer formed of a compound containing niobium and lithium, wherein the compound is a lithium ion conductor.

The positive electrode plate for a nonaqueous electrolyte secondary battery of a 2^{nd} invention includes the 1^{st} invention, wherein the compound is lithium niobate.

The positive electrode plate for a nonaqueous electrolyte secondary battery of a 3^{rd} invention includes the 2^{nd} invention, wherein the lithium niobate contains any one compound selected from the group consisting of LiNbO₃, LiNb₃O₈, and Li₃NbO₄.

The positive electrode plate for a nonaqueous electrolyte secondary battery of a 4^{th} invention includes any one of the 1^{st} invention to the 3^{rd} invention, wherein the compound is a dielectric.

The positive electrode plate for a nonaqueous electrolyte secondary battery of a 5^{th} invention includes any one of the 1^{st} invention to the 4^{th} invention, wherein the thickness of the coating layer ranges from 1 nm to 500 nm.

The positive electrode plate for a nonaqueous electrolyte secondary battery of a 6^{th} invention includes any one of the 1^{st} invention to the 5^{th} invention, wherein the positive electrode is a thin film, and the coating layer is superimposed and thus formed on the positive electrode.

The positive electrode plate for a nonaqueous electrolyte secondary battery of a 7^{th} invention includes any one of the 1^{st} invention to the 5^{th} invention, wherein the lithium metal composite oxide is in the form of particles, and the coating layer is formed on the surface of the lithium metal composite oxide particles.

The positive electrode plate for a nonaqueous electrolyte secondary battery of an 8^{th} invention includes the 7^{th} invention, wherein the amount of niobium contained in the coating layer ranges from 0.05 atom % to 5.0 atom % with respect to the total amount of metallic elements other than lithium contained in the lithium metal composite oxide.

The positive active material for a nonaqueous electrolyte secondary battery of a 9^{th} invention is a positive active material to be used for the positive electrode plate for a nonaqueous electrolyte secondary battery of the 7^{th} or the 8^{th} invention, wherein the coating layer is formed on the surface of the lithium metal composite oxide particles.

The nonaqueous electrolyte secondary battery of a 10^{th} invention includes any one of the 1^{st} invention to the 8^{th} invention used as the positive electrode plate.

### Advantageous Effects of Invention

According to the 1^{st} invention, the positive electrode plate for a nonaqueous electrolyte secondary battery has a positive electrode composed of a positive active material comprising a lithium metal composite oxide, and on the surface of the positive electrode, an amorphous coating layer formed of a compound containing niobium and lithium, wherein the compound is a lithium ion conductor, so as to be able to improve lithium ion conductivity in the electrode plate, and suppress the deterioration of the lithium ion conductivity in air. Therefore, the use of the electrode plate makes it possible to provide a positive electrode plate for a nonaqueous electrolyte secondary battery being capable of realizing an increased output, and having high output performance that is difficult to be deteriorated when handled in air.

According to the 2^{nd} invention, the compound forming the coating layer is lithium niobate, and thus is stable against an electrolyte to be used for a nonaqueous electrolyte secondary battery, and can lower a detrimental effect on the battery due to elution of niobium or the like.

According to the 3^{rd} invention, lithium niobate contains any one compound selected from the group consisting of LiNbO₃, LiNb₃O₈, and Li₃NbO₄, and thus lithium niobate can be produced stably.

According to the 4^{th} invention, the compound forming the coating layer is a dielectric, and thus lithium insertion and de-insertion at the interface of the surface coating layer and the positive active material can further be improved. Therefore, a positive electrode plate for a nonaqueous electrolyte secondary battery capable of realizing a further increased output can be provided using the electrode plate.

According to the 5^{th} invention, the thickness of the coating layer ranges from 1 nm to 500 nm, which sufficiently ensures to obtain a coating layer with high lithium ion conductivity and weather resistance, and thus the output characteristics of the battery can be improved, the deterioration of the output characteristics in air can be suppressed, and production thereof can be further easily performed.

According to the 6^{th} invention, the positive electrode is a thin film and the coating layer is superimposed and thus formed on the positive electrode. Hence, this ensures to provide the diffusion paths of lithium ions between the thin-film positive electrode and an electrolytic solution, increases the output of a battery produced using the thin-film positive electrode, and makes it possible to suppress the deterioration of output characteristics when the battery is handled in air.

According to the 7^{th} invention, the lithium metal composite oxide is in the form of particles, and the coating layer is formed on the surface of the lithium metal composite oxide particles, so as to be able to ensure the provision of the diffusion paths of lithium ions between the coating layer and the electrolytic solution, accelerate lithium insertion and de-insertion between the coating layer and the positive active material particles, realize the increased output of the battery using the positive active material particles, and suppress the deterioration of the output characteristics when the battery is handled in air.

According to the 8^{th} invention, the amount of niobium contained in the coating layer ranges from 0.05 atom % to 5.0 atom % with respect to the total amount of metallic elements other than lithium contained in the lithium metal composite oxide, by which the provision of the diffusion paths of lithium ions between the coating layer and the electrolytic solution can be more securely ensured, lithium insertion and de-insertion between the coating layer and the positive active material particles is accelerated, the output of a battery using the positive active material particles can be further increased, and the deterioration of the output characteristics when the battery is handled in air can be further suppressed.

According to the 9^{th} invention, the positive active material to be used for the positive electrode plate of the 7^{th} invention or the 8^{th} invention has a coating layer of lithium niobate or the like formed on the surface of the lithium metal composite oxide particles, so that the lithium ion conductivity of the positive active material can be improved and deterioration of the performance can be suppressed.

According to the 10^{th} invention, the nonaqueous electrolyte secondary battery, in which the positive electrode plate of the 1^{st} invention to the 8^{th} invention is used, enables to increase the output of the secondary battery, and to suppress the deterioration of the increased output performance.

### BRIEF DESCRIPTION OF DRAWINGS

FIG. 1 is a schematic diagram showing a section of the structure of the thin-film positive electrode according to a 1^{st} embodiment of the present invention.

FIG. 2 is an enlarged view showing the surface of the positive active material particles according to a 2^{nd} embodiment of the present invention.

FIG. 3 is a schematic explanatory diagram of a battery using the positive electrode plate according to the 1^{st} embodiment of the present invention.

FIG. 4 is a graph showing the results of measuring the impedance spectrum of the positive electrode plate according to the 1^{st} embodiment of the present invention.

FIG. 5 is an explanatory diagram of an equivalent circuit used for analysis.

### DESCRIPTION OF EMBODIMENTS

The positive electrode plate for a nonaqueous electrolyte secondary battery (hereinafter, simply referred to as “positive electrode plate”) and the nonaqueous electrolyte secondary battery (hereinafter, simply referred to as “battery”) of the present invention are: a positive electrode plate wherein the surface of a lithium metal composite oxide is coated with a compound containing niobium and lithium; and a battery that is composed of the positive electrode plate, a separator, a negative electrode, and an electrolytic solution.

A lithium metal composite oxide material to be used as a raw material for a lithium metal composite oxide thin film to be used for the positive electrode plate may be a layer-type lithium composite oxide as long as high voltage as high as 4V can be obtained, the direction of lithium diffusion is limited to a- and b-surface directions, and examples thereof include lithium-cobalt composite oxide (LiCoO₂), lithium-nickel composite oxide (LiNiO₂), and lithium nickel cobalt manganese composite oxide (LiNi_{1/3}Co_{1/3}Mn_{1/3}O₂). Of these examples, LiCoO₂ that can be relatively easily synthesized, is preferable. Preferably, the powder of the lithium metal composite oxide material is sintered to prepare a target, and then a lithium metal composite oxide thin film is deposited on a conductive substrate such as Pt/Cr/SiO₂ or Pt by a PLD technique.

A coating layer comprising a lithium ion conductive oxide to be provided on the surface of the lithium metal composite oxide thin film of the positive electrode plate is formed of a compound containing niobium and lithium. The compound containing niobium and lithium is excellent in lithium ion conductivity since the diffusion paths of lithium ions are present in multiple directions, thereby accelerating lithium insertion and de-insertion, and enabling an increased output of the battery. Moreover, the compound is difficult to be altered in air and thus is stable. As such a substance, lithium niobate such as LiNbO₃, LiNb₃O₈, or Li₃NbO₄ is preferable.

Furthermore, the compound containing niobium and lithium is preferably a dielectric, whereby lithium insertion and de-insertion between the coating layer and the positive active material particles are accelerated, and a further increased output of the battery becomes possible. This may be because lithium insertion and de-insertion at the interface of the dielectric and the active material are accelerated by the polarization effect of the dielectric.

The coating film comprising a lithium ion conductive oxide has preferably a thickness ranging from 1 nm to 500 nm. The coating layer having a thickness ranging from 1 nm to 500 nm can sufficiently ensure to provide a coating layer having lithium ion conductivity and weather resistance, so that the output characteristics of the battery can be improved, the deterioration of the output characteristics in air can be suppressed, and the production can be easily performed. On the other hand, the coating film having a thickness of less than 1 nm can cause the ineffective functioning of the diffusion paths of lithium ions, and the same exceeding 500 nm results in excessively long diffusion paths, which can lead to insufficient improvement in charge and discharge capacity and output characteristics.

The state of the lithium niobate is an amorphous state having a channel structure effective for lithium ion diffusion. An amorphous state is better than a crystal state in terms of lithium ion conductivity, and is difficult to be altered in air.

The positive electrode plate according to the present invention is obtained by sintering the above powder containing niobium and lithium to prepare a target, and then depositing the compound containing niobium and lithium on the lithium metal composite oxide thin film by the PLD technique, for example.

When only the above lithium metal composite oxide thin film is used as a positive electrode plate and handled in air, the film reacts with water and carbon dioxide contained in air, so that lithium on the outermost surface of the lithium metal composite oxide is eliminated and becomes depleted, the metal is oxidized and inactivated to be unable to contribute to charge and discharge, and decreased capacity and increased resistance at the electrolytic solution/positive electrode interface are induced. On the other hand, in the case of a positive electrode plate, in which the surface of a lithium metal composite oxide is coated with a compound containing niobium and lithium such as lithium niobate poorly reacting with water and carbon dioxide in air or the like, the compound containing niobium and lithium functions as a protective coating, so as to prevent the lithium metal composite oxide from directly contacting with the atmosphere, and thus deterioration is suppressed even when handled in air. Moreover, the compound containing niobium and lithium is used as a protective coating, and thus lithium ion conduction is maintained. Accordingly, the compound containing niobium and lithium is preferably superimposed all over the surface of a positive electrode so as to be applied as a thin film. The PLD technique is preferably employed, since a target comprising the compound containing niobium and lithium is evaporated by a laser, so as to be able to control the film thickness and the crystal state of a lithium ion conductive oxide, and to coat all over the surface of the lithium metal composite oxide thin film. In addition, even when the compound containing niobium and lithium is partially applied, deterioration in performance of lithium ion conductivity of the coated area is suppressed, and thus deterioration in battery performance can be suppressed.

If a battery is produced using only the lithium metal composite oxide thin film as a positive electrode, adhesion of components such as phosphate resulting from decomposition of an electrolytic solution, and contact with the electrolytic solution take place onto the surface of the positive electrode, and effects such as Co elution from the surface of the positive electrode inhibit lithium ion diffusion at the electrolytic solution/positive electrode interface, resulting in increased resistance at the electrolytic solution/positive electrode interface. Meanwhile, in the case of a positive electrode in which the surface of a lithium metal composite oxide thin film is coated with a compound containing niobium and lithium, such as lithium niobate, excellent in lithium diffusion, the compound functions as a protective coating, which prevent the contact between the positive electrode and the electrolytic solution, with good permeation of lithium ions. Hence, resistance at the electrolytic solution/positive electrode interface in this case is significantly reduced compared with a case in which only a lithium metal composite oxide thin film is used as a positive electrode, and the output characteristics can be improved. Therefore, the lithium ion conductive oxide is preferably applied all over the surface of a positive electrode.

The preparation of a battery composed of the above thin-film positive electrode, a separator, a negative electrode from which lithium can be inserted and eliminated, and an electrolytic solution, enables to easily provide a positive electrode material for a nonaqueous electrolyte secondary battery capable of realizing high output and the secondary battery. Each component of the battery will be described in detail as follows.

(1) Positive Electrode

A thin-film positive electrode for forming a positive electrode is described. Parts composing the positive electrode are a positive electrode and a collector.

A positive active material to be used as a raw material for the positive electrode may be a layer-type lithium composite oxide, as long as high voltage as high as 4V is obtained and the directions of lithium diffusion are limited to a- and b-surface directions. For example, lithium metal composite oxide materials such as lithium-cobalt composite oxide (LiCoO₂), lithium-nickel composite oxide (LiNiO₂), and lithium nickel cobalt manganese composite oxide (LiNi_{1/3}Co_{1/3}Mn_{1/3}O₂) are used.

For example, a thin-film positive electrode is prepared by sintering the above lithium metal composite oxide powder to be used as a raw material to prepare a target, and then depositing a lithium metal composite oxide thin film on a conductive substrate serving as a collector such as Pt/Cr/SiO₂ or Pt cut in advance into a size appropriate for the collector, by a physical deposition technique such as a PLD technique, a sputtering deposition technique, and a molecular beam epitaxy technique.

Note that in the present invention, a lithium ion conductive oxide thin film, that is, preferably a thin film further having good dielectricity, is further deposited on the lithium metal composite oxide thin film. At this time, the above physical deposition techniques are preferably employed. A raw material of the compound containing niobium and lithium, for forming a coating layer of a positive electrode plate by the physical deposition technique, may be a target containing niobium and lithium and is preferably lithium niobate.

For example, a positive electrode is preferably prepared by preparing the above target containing niobium and lithium by sintering, and then depositing a lithium ion conductive oxide thin film on the surface of the above thin-film positive electrode by the PLD technique.

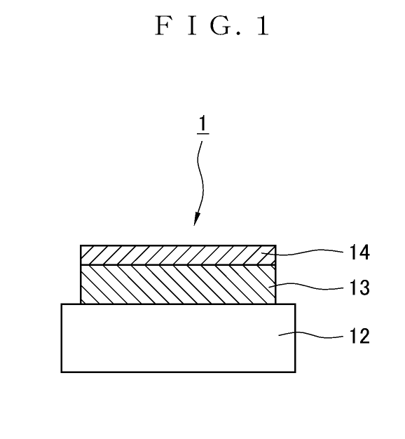

FIG. 1 is a schematic diagram showing a section of the structure of the thin-film positive electrode 1 according to the 1^{st} embodiment of the present invention. In the thin-film positive electrode 1, a positive active material 13 that is a lithium metal composite oxide is deposited in the form of thin film on a substrate 12 that is a collector, followed by superimposition, so that a lithium ion conductive oxide 14 that is lithium niobate, for example, having good dielectricity is formed in the form of thin film.

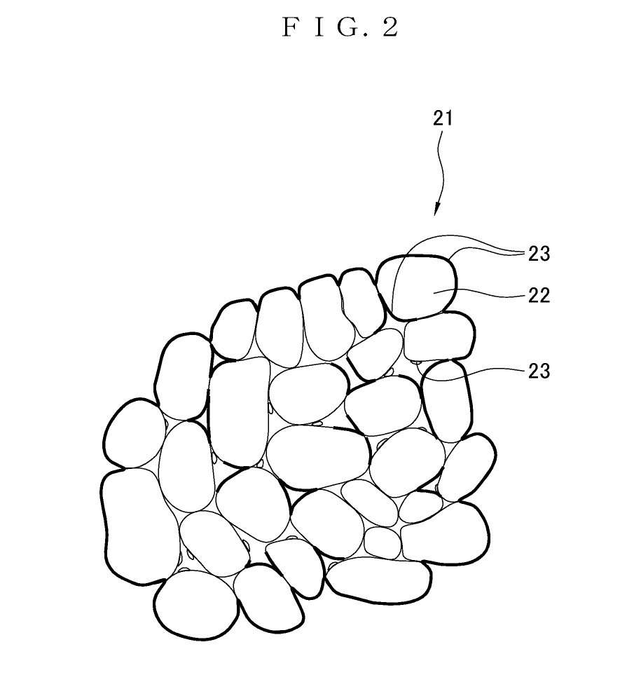

FIG. 2 is an enlarged view showing the surface of positive active material particles 21 according to the 2^{nd} embodiment of the present invention. In the positive active material particles 21, a coating layer comprising a thin-film lithium ion conductive oxide 23 is provided on primary particles, lithium metal composite oxide 22, or on secondary particles comprising these primary particles. The positive active material particles may be primary particles or secondary particles formed of aggregated primary particles, or a mixture of primary particles and secondary particles. When the positive active material particles are composed of the secondary particles, a coating layer is preferably provided also in the interior thereof. However, when a thin-film coating layer is provided all over the surface of the secondary particles, no coating layer may be provided in the interior thereof.

The amount of niobium contained in the above coating layer preferably ranges from 0.05 atom % to 5.0 atom % with respect to the total amount of metallic elements other than lithium contained in the lithium metal composite oxide. Therefore, the positive active material particles 21 are sufficiently provided with a coating layer, the provision of diffusion paths of lithium ions between the layer and an electrolytic solution can be ensured more securely, and a further increased output of a battery using positive active material particles 21 can be obtained. Furthermore, the contact of the positive active material particles 21 with atmosphere is sufficiently suppressed, so that deterioration of output characteristics in air can be further suppressed.

When a positive electrode is formed using the positive active material particles 21, the positive electrode can be obtained, in the same manner as that for a general positive electrode of a nonaqueous electrolyte secondary battery, by mixing and kneading the positive active material particles 21 with a conductive material such as carbon powder, a binder, and a solvent, so as to obtain a paste, and then applying the paste onto a collector.

(2) Negative Electrode

A negative electrode may be formed of any material that enables lithium insertion and de-insertion as described above. Similar to a general negative electrode of a nonaqueous electrolyte secondary battery, a powdery carbon substance applied onto a collector can be used herein. In the case of coin cells, metal lithium, or lithium alloys are preferably used. Metal lithium or a lithium alloy composing a negative electrode preferably has a thickness ranging from 0.5 mm to 2.0 mm, so as not to allow the coin cell to swell. An area with a diameter of about 5 mm to 15 mm should be hollowed out from the negative electrode, so that it is fitted within the coin cell. Hence, the negative electrode preferably has an area larger than that of a positive electrode.

(3) Separator

A separator is placed between a positive electrode and a negative electrode. The separator has a function of insulating between the positive electrode and the negative electrode, and a function of retaining an electrolytic solution, for example. A separator that is used for general nonaqueous electrolyte secondary batteries can be used herein. Examples thereof may be those having required functions thereof, and include porous films such as polyethylene (PE), polypropylene (PP), glass (SiO₂) or laminates thereof, and are not particularly limited, as long as it is a separator that is used for a general nonaqueous electrolyte secondary battery and contains no measurement interfering elements.

(4) Nonaqueous Electrolytic Solution

A nonaqueous electrolytic solution is prepared by dissolving a lithium salt as an electrolyte in an organic solvent. As an organic solvent, one type alone selected from a cyclic carbonate such as ethylene carbonate, propylene carbonate, butylene carbonate, and trifluoropropylene carbonate, and a chain carbonate such as diethyl carbonate, dimethyl carbonate, ethylmethyl carbonate, and dipropyl carbonate, and furthermore, an ether compound such as tetrahydrofuran, 2-methyltetrahydrofuran, and dimethoxyethane, a sulfur compound such as ethyl methyl sulfone, butane sultone, a phosphorus compound such as triethyl phosphate, and trioctyl phosphate can be used, or two or more types thereof can be mixed and used.

As an electrolyte, LiPF₆, LiBF₄, LiClO₄, LiAsF₆, LiN(CF₃SO₂)₂ or the like, and a composite salt thereof can be used. Furthermore, the nonaqueous electrolytic solution may contain a radical scavenger, a surfactant, a fire retardant and the like.

(5) Battery Configuration

The above positive electrode and negative electrode are superimposed via a separator to form an electrode body, and then the electrode body is impregnated with the above nonaqueous electrolytic solution. The positive electrode and the negative electrode are each connected to external terminals for conduction. These components are placed in a metal container to prepare a battery.

### COMPARATIVE EXAMPLE 1

In this comparative example, a LiCoO₂ thin film was used as a positive active material.

The LiCoO₂ thin film was prepared by a PLD technique. Li₂CO₃ and Co₃O₄ were mixed to give a LiCoO₂ composition, and then the resultant was fired under an oxygen atmosphere at 980° C., thereby preparing LiCoO₂ powder. Subsequently, the LiCoO₂ powder was sintered at 1000° C., so as to prepare a pellet. With the use of this pellet as a target, under an oxygen atmosphere at 500° C., a LiCoO₂ thin film (positive active material 13) alone with an area of 8 mm×8 mm and thickness of about 300 nm was formed on a Pt substrate (substrate 12), thereby preparing a thin-film positive electrode 1.

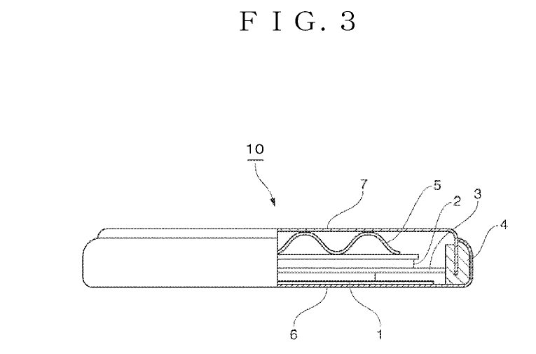

The thus obtained positive active material for a nonaqueous electrolyte secondary battery was evaluated by preparing a battery shown in FIG. 3 as follows, and then measuring the positive electrode interface resistance and rate characteristics.

A 2032 coin type battery 10 was prepared using a thin-film positive electrode 1 (electrode for evaluation) within a glove box in which the dew point of an Ar atmosphere was maintained at −80° C.

As a negative electrode 2, a negative electrode sheet stamped into a disk shape with a diameter of 14 mm, and having a copper foil coated with graphite powder with a mean particle diameter of about 20 μm and polyvinylidene fluoride was used. As an electrolytic solution, a mixture of ethylene carbonate (EC) and diethyl carbonate (DEC) mixed in equivalent amounts (Ube Industries, Ltd.) containing 1M LiPF₆ as a supporting electrolyte was used. As a separator 3, a polyethylene porous film having a film thickness of 25 μm was used. Furthermore, the coin type battery 10 having a gasket 4 and a wave washer 5 was assembled into a coin-shaped battery with a positive electrode can 6 and a negative electrode can 7.

<Positive Electrode Interface Resistance>

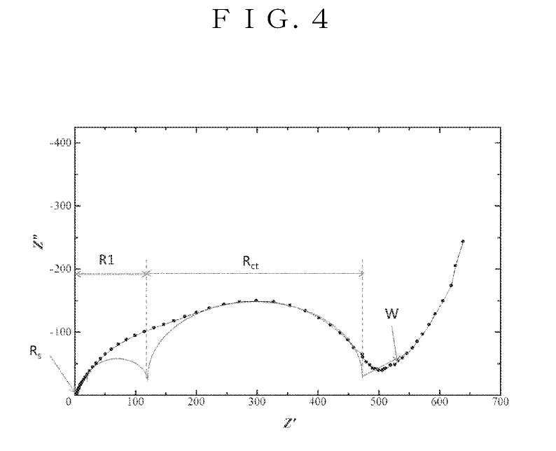

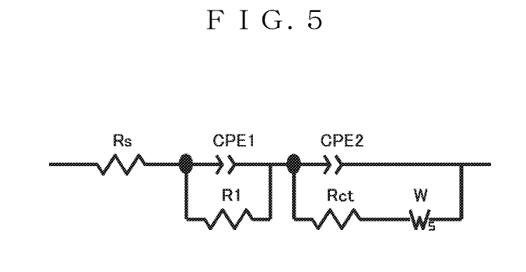

Regarding positive electrode interface resistance, the coin type battery 10 was charged up to a charging potential of 4.0V, alternating-current impedance was measured using a frequency response analyzer and a potentiogalvanostat, and then an impedance spectrum shown in FIG. 4 was obtained. In the thus obtained impedance spectrum, two semicircles were observed in a high frequency region and in an intermediate frequency region, and a straight line was observed in a low frequency region. Hence, an equivalent circuit model shown in FIG. 5 was assembled and then positive electrode interface resistance was analyzed. Here, Rs indicates a bulk resistor, R1 indicates positive electrode film resistance, Rct indicates electrolytic solution/positive electrode interface resistance (Li⁺ transfer resistance at the interface), W indicates a Warburg component, and CPE1 and CPE2 indicate constant phase elements.

<Rate Characteristics>

A charge and discharge voltage range employed herein was 3.0V-4.2V, and charge and discharge were performed at rates of 0.3 C, 0.6 C, 3 C, and 10 C. The ratios of discharge capacity at 0.6 C, 3 C and 10 C to discharge capacity at 0.3 C were found for evaluation of rate characteristics.

### EXAMPLE 1

In this Example, a LiCoO₂ thin film was used as a positive active material, and on the surface, a LiNbO₃ thin film was formed as a lithium ion conductive oxide having good dielectricity.

On the LiCoO₂ thin film (positive active material 13) prepared under conditions similar to Comparative example 1, a LiNbO₃ thin film (lithium ion conductive oxide 14) was formed, thereby preparing a thin-film positive electrode 1. The PLD technique was employed for preparation of the thin film in the same manner as that for LiCoO₂. Li₂O and Nb₂O₅ were mixed, and then sintered to prepare a pellet as a target. With the use of this target, a LiNbO₃ thin film was further formed on the LiCoO₂ thin film obtained above at 25° C. under oxygen partial pressure of 20 Pa to have a thickness of about 300 nm, thereby preparing a positive electrode thin film. The positive electrode thin film was analyzed by XRD for confirming the state of LiNbO₃, and thus the state was found to be an amorphous state. Moreover, the positive electrode thin film was heated at 700° C. for 2.5 hours and then subjected to XRD measurement, and thus the film was confirmed to be LiNbO₃. Next, a coin type cell was prepared in the same manner as in Comparative example 1 using the thus prepared amorphous positive electrode thin film, followed by comparison for battery performance. Table 1 shows the results.

TABLE 1

| | | | | | Positive | 0.6 C/0.3 C | 3 C/0.3 C | 10 C/0.3 C |
|---|---|---|---|---|---|---|---|---|
| | | | | Weather | electrode | Discharge | Discharge | Discharge |
| | Positive | | Negative | resistance | interface | capacity | capacity | capacity |
| | electrode | Coating | electrode | test | resistance | ratio | ratio | ratio |
| | layer | layer | layer | Yes/No | Ω | % | % | % |
| Example 1 | LiCoO₂ | LiNbO₃ | Li metal | No | 441 | 97.4 | 90.0 | 83.2 |
| Comparative | LiCoO₂ | None | Li metal | No | 887 | 96.0 | 86.3 | 55.8 |
| example 1 | | | | | | | | |

As is understood from Table 1, compared with the LiCoO₂ thin film of Comparative example 1, the LiCoO₂ thin film with amorphous LiNbO₃ deposited thereon exerted significantly reduced positive electrode interface resistance and improved output characteristics. The reason for this is considered to be that through coat of amorphous lithium niobate being excellent in lithium ion conductivity and having good dielectricity, the lithium diffusion property of the positive electrode was improved and the resistance at the electrolytic solution/positive electrode interface was more significantly reduced compared with the LiCoO₂ thin film. Moreover, compared with the LiCoO₂ thin film of Comparative example 1, the LiCoO₂ thin film with amorphous LiNbO₃ deposited thereon was found to have improved rate characteristics. It is considered that because of the significantly reduced resistance at the electrolytic solution/positive electrode interface, the LiCoO₂ thin film coated with LiNbO₃ was able to keep up with high-speed charge and discharge, with which the uncoated LiCoO₂ thin film was unable to keep up.

### COMPARATIVE EXAMPLE 1a

In this Example, a LiCoO₂ thin film was used as a positive active material. The positive active material was exposed to a high humidity environment with an ambient temperature of 80° C. and relative humidity of 60% for 24 hours, a coin type battery 10 was prepared, and then impedance measurement was performed.

A LiCoO₂ thin film was prepared in the same manner as in Comparative example 1, a thin-film positive electrode 1 comprising the LiCoO₂ thin film was exposed to a high humidity environment with an ambient temperature of 80° C. and relative humidity of 60% for 24 hours, a coin type battery 10 was prepared, and then the battery performance was confirmed. Table 2 shows the results. Compared with the result of Comparative example 1 shown in Table 1, positive electrode interface resistance was significantly increased. The reason for this is considered to be that as a result of exposure to air under high humidity conditions, the surface of the LiCoO₂ thin film reacted with water and carbon dioxide in air to be inert Co₃O₄ unable to contribute to charge and discharge, causing increased interface resistance. Furthermore, it is considered that as a result of increased interface resistance, rate characteristics became worse.

TABLE 2

| | | | | | Positive | 0.6 C/0.3 C | 3 C/0.3 C | 10 C/0.3 C |
|---|---|---|---|---|---|---|---|---|
| | | | | Weather | electrode | Discharge | Discharge | Discharge |
| | Positive | | Negative | resistance | interface | capacity | capacity | capacity |
| | electrode | Coating | electrode | test | resistance | ratio | ratio | ratio |
| | layer | layer | layer | Yes/No | Ω | % | % | % |
| Example 1a | LiCoO₂ | LiNbO₃ | Li metal | Yes | 819 | 97.2 | 88.9 | 80.5 |
| Comparative | LiCoO₂ | None | Li metal | Yes | 2751 | 94.0 | 77.9 | 1.7 |
| example 1a | | | | | | | | |

### EXAMPLE 1a

In this Example, a LiCoO₂ thin film was used as a positive active material, and on the surface, a LiNbO₃ thin film was formed as a lithium ion conductive oxide having good dielectricity, so as to prepare a thin-film positive electrode 1. These procedures are the same as those in Example 1. After that, in the same manner as in Comparative example 1a, the thus prepared thin-film positive electrode 1 was exposed to a high humidity environment with an ambient temperature of 80° C. and relative humidity of 60% for 24 hours, a coin cell was prepared, and then impedance measurement was performed.

Table 2 shows the positive electrode interface resistance and the rate characteristics in Example 1a. Compared with Comparative example 1a, the value of positive electrode interface resistance was lower and the rate of increase compared with Example 1 was suppressed. The same applies to rate characteristics. This may be because the coating of LiCoO₂ surface with LiNbO₃ that is very stable in air caused LiNbO₃ to serve as a protective coating so as to suppress the direct contact of LiCoO₂ with the atmosphere, thereby suppressing deterioration of LiCoO₂. Moreover, it is considered that LiNbO₃ is very stable in air, is not easily altered, and thus is capable of maintaining lithium ion conductivity and dielectricity even when exposed in air, so that resistance at the positive electrode interface increases with difficulty. Furthermore, compared with (Comparative example 2), rate characteristics were found to be improved. It is considered that since generation of a deteriorated layer was suppressed, the coin cell of Example 1a was able to keep up with high-speed charge and discharge.

### INDUSTRIAL APPLICABILITY

The positive electrode material for a nonaqueous electrolyte secondary battery of the present invention and the secondary battery are suitable for batteries of electric cars and hybrid cars requiring high output. Furthermore, the positive electrode material can be applied to various lithium composite oxides, lithium ion conductive oxides, and dielectric materials, regardless of various characteristics including material solubility. Furthermore, a lithium ion conductive oxide having good dielectricity can be directly deposited on the surface of a lithium composite oxide, and thus application of the present invention to development of a positive electrode material for a nonaqueous electrolyte secondary battery can be expected. Moreover, the present invention is considered to be useful in elucidation of the phenomenon at the interface of a lithium composite oxide and lithium ion conductive oxide through analyses with combinations of various analytical techniques.

### REFERENCE SIGNS LIST

1 Thin-film positive electrode

2 Negative electrode

3 Separator

4 Gasket

5 Wave washer

6 Positive electrode can

7 Negative electrode can

10 Coin type battery

12 Substrate

13 Positive active material

14 Lithium ion conductive oxide

21 Positive active material particles

22 Positive active material

23 Lithium ion conductive oxide

1. A positive electrode plate used in a nonaqueous electrolyte secondary battery, in which an electrolyte is a nonaqueous electrolytic solution, the positive electrode plate having:
a positive electrode composed of a positive active material comprising a lithium metal composite oxide; and
an amorphous coating layer formed of a compound containing niobium and lithium on the surface of the positive electrode, wherein
the compound is a lithium ion conductor.

2. The positive electrode plate for a nonaqueous electrolyte secondary battery according to claim 1, wherein the compound is lithium niobate.

3. The positive electrode plate for a nonaqueous electrolyte secondary battery according to claim 2, wherein the lithium niobate contains any one compound selected from the group consisting of LiNbO₃, LiNb₃O₈, and Li₃NbO₄.

4. The positive electrode plate for a nonaqueous electrolyte secondary battery according to claim 1, wherein the compound is a dielectric.

5. The positive electrode plate for a nonaqueous electrolyte secondary battery according to claim 1, wherein the thickness of the coating layer ranges from 1 nm to 500 nm.

6. The positive electrode plate for a nonaqueous electrolyte secondary battery according to claim 1, wherein the positive electrode is a thin film and the coating layer is superimposed and formed on the positive electrode.

7. The positive electrode plate for a nonaqueous electrolyte secondary battery according to claim 1, wherein the lithium metal composite oxide is particulate, and the coating layer is formed on the surface of the lithium metal composite oxide particles.

8. The positive electrode plate for a nonaqueous electrolyte secondary battery according to claim 7, wherein the amount of niobium contained in the coating layer ranges from 0.05 atom % to 5.0 atom % with respect to the total amount of metallic elements other than lithium contained in the lithium metal composite oxide.

9. A positive active material for a nonaqueous electrolyte secondary battery, which is a positive active material to be used for the positive electrode plate for a nonaqueous electrolyte secondary battery according to claim 7, wherein
the coating layer is formed on the surface of the lithium metal composite oxide particles.

10. A nonaqueous electrolyte secondary battery, wherein the positive electrode plate according to claim 1 is used.
